(19) United States
(12) Patent Application Publication
(10) Pub. No.: US 2005/0175765 A1
(43) Pub. Date: Aug. 11, 2005

(54) Soy-containing chocolate products

(76) Inventor: Hassan Zaki, Hamburg (DE)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/049,457

(22) Filed: Feb. 2, 2005

Related U.S. Application Data
(60) Provisional application No. 60/541,790, filed on Feb. 3, 2004.

(51) Int. Cl. A23C 1/00

(52) U.S. Cl. 426/631

(57) ABSTRACT

A soy-containing chocolate product having qualities akin to milk chocolate. The chocolate product is prepared from a mixture of chocolate liquor, cocoa butter, a sweetener, and whole soybean powder. A method of making the chocolate product also is provided.

### CROSS REFERENCE TO RELATED APPLICATIONS

This application claims the benefit of U.S. Provisional Patent Application No. 60/541,790, filed Feb. 3, 2004, which is incorporated herein by reference in its entirety.

### BACKGROUND

1. Field of the Invention

Soy-containing chocolate products, methods of making soy-containing chocolate products and methods of improving the health benefits of chocolate products are provided.

2. Description of the Related Art

Chocolate is said to have magical qualities. Its mass consumer appeal is testament to this statement. The desirability of chocolate products, often described as a craving in some individuals, likely is due to the presence of certain organic compounds, such as polyphenols in refined chocolate.

Chocolate is prepared from cacao seeds. In a typical process for making chocolate, the cacao seeds are fermented and dried. The seeds are then cracked to remove the seed husks and to break the seeds into small pieces called nibs. Blowers typically are used to separate the seed husks from the nibs. The nibs are sterilized and roasted and then the roasted nibs are ground or milled to prepare a thick paste known as chocolate or cocoa liquor. Cocoa liquor contains about half cocoa butter and half cocoa solids and is the principal constituent of unsweetened baking chocolate. Chocolate liquor can be pressed to separate the cocoa butter from the solid cocoa powder.

Chocolate may be prepared from a variety of ingredients. Recipes for different chocolate products vary by product and manufacturer. Nevertheless, recipes for certain common chocolate types typically fall within certain parameters. For example, European chocolate typically is milder, treated chocolate liquor. Sweet dark chocolate typically contains 15% to 35% chocolate liquor and less than 12% milk solids. Semi-sweet or bittersweet chocolate typically contains at least 35% chocolate liquor in addition to sugar and cocoa butter. Milk chocolate typically is a mixture of chocolate liquor, cocoa butter, milk, sugar and other flavorings. Chocolate coatings or compounds typically are prepared from cocoa powder and vegetable oils other than cocoa butter. White chocolate typically is a blend of cocoa butter, milk, sugar and other flavorings, but contains no cocoa solids. Cocoa butter generally is added to chocolate products for numerous reasons, both technological and legal, for example cocoa butter may be added to keep the product solid at room temperature, but permits the product to melt in the mouth. Chocolate product recipes often contain other flavorings, such as, without limitation a vanilla flavoring, such as vanillin.

Continuing with the typical processing of chocolate, the chocolate liquor is blended with other ingredients to form a raw chocolate mixture. The mixture is refined by passage through a multi-stage roller assembly, known as a refiner, that breaks down the particles within the mixture to a desired size, typically below the point where the mouth can distinguish the individual particles of cocoa solid, sugar or milk powder, which is about 0.0005 inches. The degree of refining typically depends on the final application for the chocolate and also can be a matter of taste. Swiss and German chocolates typically are refined for a longer period, yielding a smoother and finer chocolate than American or English chocolate.

After refining, the chocolate mixture is processed in an apparatus known as a “conche.” Conches vary in their design, but during the conching stage, the chocolate is rolled, kneaded, blended, ground, heated and/or aerated for a period of time particular to the particular conche and as selected by the particular manufacturer to produce a chocolate product having the desired flavor, aroma and physical qualities. The result is a refining and modification of the flavor of the chocolate, often referred to as a mellowing. Although the recipe for the chocolate greatly affects the flavor, aroma and texture of the final chocolate product, the art of the chocolateir is to establish the refining and conching conditions that ultimately define the final chocolate product. Conching may be conducted in two stages, dry conching and wet conching. In dry conching, the flavor profile of the chocolate begins to build and in wet conching, the final flavor profile and the rheology of the chocolate are developed. Each manufacturer has its own chocolate recipes and processing conditions and many manufacturers tightly guard these recipes and processing conditions.

Milk chocolate contains, despite its appeal, significant amounts of butterfat and lactose that derive from the condensed milk or milk powder used in its preparation. The presence of lactose in milk chocolate can cause difficulty in lactose intolerant individuals. Further, the fat content that is attributable to the butterfat content of the milk is less desirable in today's health-conscious consumer market. Thus, there remains a need for a lower-fat, lactose-free chocolate product substitute for milk chocolate.

### SUMMARY

A chocolate product is provided that has substantial taste and textural qualities of milk chocolate without the addition of milk. The product contains ground soybeans, chocolate liquor, cocoa butter and sugar. Emulsifiers and other flavoring, such as vanilla, also may be included in the product. Methods for making this chocolate product also are provided. The product finds use as, without limitation: a confectionary, such as a chocolate bar or drop; as a coating for other food products, such as an ice cream coating or topping; as a baking ingredient in the production of baked goods, such as muffins, pancakes and biscuits; as a cereal ingredient; or as an ingredient in a chocolate drink.

In one embodiment, a chocolate product is provided that includes, that is it is prepared from, cocoa liquor, cocoa butter, a sweetener and whole soybean powder. The chocolate product also can further include an emulsifier, such as, without limitation, lecithin, and a flavoring, such as, without limitation, a vanilla flavoring, for instance vanillin. The sweetener can be a natural sweetener, such as sugar, or an artificial sweetener, such as aspartame.

In one particular embodiment, the chocolate product includes from about 15% wt. to about 30% wt. cocoa liquor; from about 30% wt. to about 40% wt. sugar; from about 12% wt. to about 20% wt. whole soybean powder; from about 25% wt. to about 35% wt. cocoa butter; about 0.03% wt. vanillin; and/or from about 0.4% wt. to about 0.5% wt. emulsifier.

Methods for making the above-described chocolate product also are provided. In one embodiment, the chocolate product is prepared by processing a mixture of cocoa liquor, cocoa butter, a sweetener and whole soybean powder to produce a chocolate product, with optional ingredients including an emulsifier and flavoring. In one embodiment, the processing includes refining and conching the mixture. The refining can be preceded by a pre-refining stage, and the conching can include a dry conching stage and a wet conching stage in which a portion of the cocoa butter, for example about 20%, of the total cocoa butter used to produce the final chocolate product, is withheld from the refining stage and is slowly added along with an emulsifier in the wet conching stage.

### DETAILED DESCRIPTION

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

The chocolate product described herein is prepared from cocoa liquor, cocoa butter, a sweetener and whole soybean powder. Optional ingredients include flavorings, such as, but without limitation, vanilla flavoring and an emulsifier or emulsifiers. Cocoa liquor and cocoa butter are ingredients that are well known in the chocolate industry. Typical, but non-exclusive methods for making cocoa liquor and cocoa butter are described above. However, the terms “cocoa liquor” and “cocoa bufter” are intended to include variations of those ingredients as are known in the art of chocolate making. Other typical chocolate additives as are known in the art can be added to the chocolate product, such as, without limitation: nuts, nougat, toffee, dried fruit, hard candy or caramel. The cocoa liquor is added in any suitable quantity, so long as flavor of the final chocolate product is not substantially affected. In one particular embodiment of the chocolate product described herein, the final chocolate product can include from about 15% wt. to about 30% wt. cocoa liquor, from about 30% wt. to about 40% wt. refined white sugar, from about 12% wt. to about 20% wt. whole soybean powder, from about 25% wt. to about 35% wt. cocoa butter, about 0.03% wt vanillin and/or from about 0.4% wt. to about 0.5% wt. lecithin.

“Whole soybean powder” is finely ground whole, dehulled soybeans. The following is one common process for making whole soybean powder. In this embodiment, whole soybeans are heated, cracked and de-hulled. The beans are heat-treated to inactivate the lipoxygenase enzyme and then milled to produce a fine slurry, which is then pasteurized and homogenized. The whole soybean slurry typically is then spray-dried to produce a whole soybean powder. Various nutritive benefits are realized by the use of whole soybean powder, which contains large amounts of fiber and the beneficial compounds naturally found in the whole soybean cotyledon. A non-limiting example of a whole soybean powder is commercially available from Archer Daniels Midland Company of Decatur, Ill. as NUTRISOY® whole bean powder.

Modifications of this process, as well as other methods for making whole soybean powder exist or would be readily apparent to one of skill in the art and, for that reason, the preceding is intended to be a non-limiting example of how to make whole soybean powder. Various parameters may be changed, and additional steps may be added. For example, the pasteurization may be conducted in any acceptable manner. Non-limiting examples of pasteurization conditions include: 30 minutes at 145° F. (low temperature long time pasteurization), 15 seconds at 161° F. (high temperature short time pasteurization) and 8 seconds at 240° F. (Ultra High Temperature (UHT) pasteurization). In aseptic pasteurization, the product is packaged in sterile, sealed containers to maximize shelf life. The enzyme inactivation step can be conducted under any suitable condition, for example and without limitation, at 90° C. for 1 minute. The milling and homogenization processes also are subject to great variation, depending on the manufacturer and the machines used for each process.

Chocolate confections are products containing solid chocolate, typically milk chocolate or sweet dark chocolate, and are sold as bars, drops or other desirable shapes. Chocolate used in chocolate confections is suitable for eating by itself, as well as for use in baking, drink products or as a topping.

“Vanillin” is a white or yellowish crystalline compound, C₈H₈O₃, found in vanilla beans and certain balsams and resins and used in perfumes, flavorings, and pharmaceutical formulations. Vanillin can be of natural or synthetic origin. “Vanilla” is, in general, a flavoring having the flavor of a vanilla bean, and/or vanilla extract, which is prepared from vanilla beans steeped in alcohol.

A “sweetener” is a substance that imparts a sweet flavor to the chocolate product. A sugar is a natural sweetener, typically sucrose, that in any state of refinement is suitable for use in a chocolate product, including, without limitation, brown sugar, turbinado sugar, and white sugar as are commonly available. White, refined sugar typically is used in chocolate making. “Artificial sweeteners” are non-naturally-derived sweeteners and include as a class, without limitation, aspartame (for example, NUTRASWEET) and saccharin.

An “emulsifier” can be any emulsifier suitable for ingestion. Emulsifiers that are safe for ingestion include, without limitation, glycerin di- and mono-fatty acid esters, acetic acid esters of monoglycerides, lactic acid esters of monoglycerides, succinic acid esters of monoglycerides, diacetyl tartaric acid esters of monoglycerides, polyglycerol esters of fatty acids, polyglycerol polyricinoleates, sorbitan esters of fatty acids, propylene glycol esters of fatty acids, sucrose esters of fatty acids, calcium stearoyl-2-lactate, lecithin, enzyme-digested or enzyme-treated lecithin and ammonium phosphatide (commercially available from Palsgaard A/S, of Denmark). Certain emulsifiers, such as lecithin, polyglycerol polyricinoleates, and ammonium phosphatides may be preferred in chocolate making.

The chocolate product described herein, typically is produced in the same manner one would make milk chocolate. The cocoa liquor, cocoa butter, whole soybean powder and sweetener is mixed, refined and conched substantially in the same manner one would produce milk chocolate according to time-honored methods known to those of skill in the art of chocolate making. In one embodiment, the cocoa liquor, a majority part of the cocoa butter used in the final recipe, refined, white sugar and whole soybean powder is mixed, refined and conched. After initial conching (dry conching), the remainder of the cocoa butter and an emulsifier are added slowly to the conche (wet conching) to produce the final chocolate product. In one embodiment, about 80% wt., of the final chocolate product, of cocoa butter is added in the pre-refining chocolate product, with about 20% wt. being added during the wet conching stage. The ratio of cocoa butter added to the chocolate product before refining to the amount added during the wet conching stage can vary greatly and it is expected that the percentage of total amount of cocoa butter added to the chocolate mixture pre-refining can range from 0% to 100%, including any % wt. increments (for example and without limitation, 0.1%, 1.0%, 5% or 10% wt. increments, resulting in, for example and without limitation, 10%, 20%, 30%, 40%, 50%, 60%, 70%, 80% or 90% wt. cocoa butter being added to the chocolate mixture pre-refining), depending on the refining and conching conditions. Nevertheless, it may be preferred in many instances that at least about 50% wt. of the cocoa butter is added to the mixture pre-refining to ensure proper development of the chocolate product. Once the chocolate product is processed, it can be placed in molds, or otherwise formed as is known in the art.

### EXAMPLES

### Example 1

### Chocolate Recipes with Whole Soybean Powder

Table A provides the recipes for various chocolate products suitable for the indicated end-use. Confectionary chocolate is suitable for eating, by itself, as a chocolate bar, or in any other desired shape. Chocolate for use in cereal is an example of a chocolate product suited for use, in the form of chocolate chips or chunks, in the preparation of cereal. Chocolate for ice cream is an example of chocolate that is suitable for use as a coating for ice cream. Chocolate for use in dairy products is an example of a chocolate suitable for use as an additive to chocolate milk or shakes. Likewise, chocolate for use in baked goods is an example of chocolate that would be suitable for use as a coating or topping for a biscuit, scone, muffin or other baked good. The solid chocolate product can be used in the same manner, in the same applications (recipes) as one would use a solid chocolate such as milk chocolate. The solid chocolate product can take any form, for example as chocolate chunks or chips, or any desired size, to be used as one would use milk chocolate or other solid chocolate in a given recipe.

TABLE A

| Raw | | | | | |
|---|---|---|---|---|---|
| Material | Confectionery | Cereal | Ice cream | Dairy | Biscuit |
| Sugar | 44.47%* | 43.47% | 39.50% | 45.50% | 43.50% |
| Cocoa | 30.00% | 20.00% | 33.50% | 25.00% | 24.97% |
| butter | | | | | |
| Nutrisoy ® | 17.00% | 16.00% | 19.00% | 19.00% | 20.00% |
| Whole Bean | | | | | |
| Powder | | | | | |
| Cocoa | 08.00% | 20.00% | 07.50% | 10.00% | 11.00% |
| Liquor | | | | | |
| Emulsifiers | 00.50% | 00.50% | 00.47% | 00.47% | 00.50% |
| Vanillin | 00.03% | 00.03% | 00.03% | 00.03% | 00.03% |

% wt. of final product

For the cereal product, chocolate chunks were added to a base, granola-type cereal mixture. Granola, generally, is cereal grain(s) roasted with sugar or honey.

For the baked product, the chocolate was added to biscuit batter as chunks, the biscuits were baked and cooled according to standard methods. The chocolate product also can be melted for use in recipes for baked goods requiring melted solid chocolate, such as chocolate cake and brownie recipes, or coated atop the baked good as a coating after the baked good is baked and cooled.

A dip for ice cream was prepared as described above. The chocolate was melted and vanilla ice cream was dipped into the melted chocolate. Chocolate chips or chunks can be mixed with the ice cream in a conventional manner during preparation of the ice cream to manufacture chocolate chip ice cream and variations thereof as are known in the art.

### Example 2

### Process for Making a Soy-Enriched Chocolate Product

The chocolate products described herein were processed according to the following procedure. The dry compounds, cocoa liquor and enough cocoa butter to achieve approximately 22% fat content are mixed at 42° C. for 10 minutes at 12 RPM. The chocolate product then is pre-refined at 30° C. to about an 80 to 100 micron fineness. The pre-refined product then was refined at 30° C. to a desired fineness. In a dry conching step, the refined powder was placed in a conche (Elk 0.25 conche, commercially available from Bühler AG, Uzwil, Switzerland) with the remainder of the cocoa butter and then the vanillin. The product was then processed at 75° C. for 4 hours, on a “slow” and “left” setting. In a wet conching step, the rest of the cocoa butter is added slowly along with dropwise addition of lecithin over 2 hours at 65° C., with the conche set at “right” and “fast.”

### Example 3

### Analysis of Chocolate Products

A sensory taste panel of 19 individuals evaluated the solid chocolate, coated biscuit, and coated ice cream products described above in Example 1. Overall, the chocolate products were described as having a favorable, new and innovative chocolate flavor. Mass spectroscopy/gas chromatography (MS/GC) analysis of compounds typically associated with chocolate flavor profiles are provided in Table B (all concentrations are expressed as in μg/kg). These profiles are typical of similar traditional chocolate products.

TABLE B

| | Biscuit | Confectionery | Ice Cream |
|---|---|---|---|
| 2-Methylbutanal | 24.9 | 26.65 | 29.17 |
| 3-Methylbutanal | 95.71 | 91.61 | 87.81 |
| Ethyl-2-methylpropanoate | LOD* | LOD | LOD |
| Ethyl-2-methylbutanoate | LOD | LOD | LOD |
| Ethyl-3-methylbutanoate | LOD | | LOD |
| Dimethyltrisulfide | 2.05 | 1.90 | 1.82 |
| Trimethylpyrazine | 39.12 | 37.05 | 35.36 |
| 3-Isopropyl-2-methoxypyrazine | <LOD | <LOD | <LOD |
| 2-Ethyl-3,6-dimethylpyrazine | 2.91 | 2.76 | 2.60 |
| 2-Ethyl-3,5-dimethylpyrazine | 5.14 | 5.00 | 4.85 |
| 3-Isobutyl-2-methoxypyrazine | 85.2 | 82.40 | 77.22 |
| Phenylacetaldehyde | 12.96 | 13.02 | 13.28 |
| 2-Methyl-3-(methyldithio)-furan | 0.38 | 0.40 | 0.41 |
| beta-Damascenone | 0.44 | 0.40 | 0.37 |
| 2-Octen-delta-lactone | 25.11 | 23.35 | 22.34 |
| 2-Decen-delta-lactone | 30.72 | 28.39 | 26.40 |
| Acetic Acid | 8344.31 | 78118.46 | 66747.45 |
| 2-Methylpropanoic acid | 125.98 | 131.05 | 139.60 |
| Butanoic acid | 28.09 | 26.46 | 21.48 |
| 3-Methylbutanoic acid | 387.04 | 297.81 | 292.42 |
| 2-Methylbutanoic acid | 254.23 | 244.57 | 238.74 |
| Furaneol | 7.56 | 8.30 | 9.12 |

*LOD: result lower than the detection limit.

The structure of the solid chocolate confection prepared in the manner described herein is comparable to that of milk chocolate. The whole soybean powder-containing chocolate was cut with a knife alongside milk chocolate, with no discernable difference between the two with respect to the cutting of the chocolate or the associated sound. The hardness of the two chocolates also was analyzed using a Stevens-LFRA Texture Analyzer (Brookfield Engineering Laboratories, Inc.), with settings: distance 5 mm, speed 0.5 mm/s. Chocolate prepared with milk powder produced a reading of 600-700, while chocolate prepared with whole soybean powder produced a comparable reading of 600-700.

Whereas particular embodiments of the invention have been described herein for the purpose of illustrating the invention and not for the purpose of limiting the same, it will be appreciated by those of ordinary skill in the art that numerous variations of the details, materials and arrangement of parts may be made within the principle and scope of the invention without departing from the invention as described in the appended claims.

1. A chocolate product comprising cocoa liquor, cocoa butter, a sweetener and whole soybean powder.

2. The chocolate product of claim 1, further comprising an emulsifier.

3. The chocolate product of claim 2, wherein the emulsifier is selected from the group consisting of a lecithin, a polyglycerol polyricinoleate and an ammonium phosphatide.

4. The chocolate product of claim 1, further comprising a flavoring.

5. The chocolate product of claim 4, wherein the flavoring is a vanilla flavoring.

6. The chocolate product of claim 5, wherein the vanilla flavoring is vanillin.

7. The chocolate product of claim 1, wherein the sweetener is a sugar.

8. The chocolate product of claim 7, wherein the sugar is white, refined sugar.

9. The chocolate product of claim 1, wherein the sweetener is an artificial sweetener.

10. The chocolate product of claim 1, wherein the chocolate product comprises from about 15% wt. to about 30% wt. cocoa liquor.

11. The chocolate product of claim 1, wherein the chocolate product comprises from about 30% wt. to about 40% wt. sugar.

12. The chocolate product of claim 1, wherein the chocolate product comprises from about 12% wt. to about 20% wt. whole soybean powder.

13. The chocolate product of claim 1, wherein the chocolate product comprises from about 25% wt. to about 35% wt. cocoa butter.

14. The chocolate product of claim 1, wherein the chocolate product comprises about 0.03% wt. vanillin.

15. The chocolate product of claim 1, wherein the chocolate product comprises from about 0.4% wt. to about 0.5% wt. lecithin.

16. The chocolate product of claim 1, wherein the chocolate product comprises: from about 15% wt. to about 30% wt. cocoa liquor; from about 30% wt. to about 40% wt. sugar; from about 12% wt. to about 20% wt. whole soybean powder; from about 25% wt. to about 35% wt. cocoa butter; about 0.03% wt. vanillin; and from about 0.4% wt. to about 0.5% wt. lecithin.

17. The chocolate product of claim 1, prepared by refining and conching a mixture comprising cocoa liquor, cocoa butter, a sweetener and whole soybean powder.

18. The method of claim 17, in which conching comprises wet conching and dry conching the mixture.

19. A chocolate product comprising: from about 15% wt. to about 30% wt. cocoa liquor; from about 30% wt. to about 40% wt. sugar; from about 12% wt. to about 20% wt. whole soybean powder; and from about 25% wt. to about 35% wt. cocoa butter.

20. The chocolate product of claim 19, further comprising flavoring and an emulsifier.

21. The chocolate product of claim 20, comprising about 0.03% wt. vanillin and from about 0.4% wt. to about 0.5% wt. lecithin.

22. A method of making a chocolate product comprising processing a mixture of cocoa liquor, cocoa butter, a sweetener and whole soybean powder to produce a chocolate product.

23. The method of claim 22, wherein the mixture further comprises an emulsifier.

24. The method of claim 23, wherein the emulsifier is selected from the group consisting of a lecithin, a polyglycerol polyricinoleate and an ammonium phosphatide.

25. The method of claim 22, wherein the mixture further comprises a flavoring.

26. The method of claim 25, wherein the flavoring is a vanilla flavoring.

27. The method of claim 26, wherein the vanilla flavoring is vanillin.

28. The method of claim 22, wherein the sweetener is a sugar.

29. The method of claim 28, wherein the sugar is white, refined sugar.

30. The method of claim 22, wherein the sweetener is an artificial sweetener.

31. The method of claim 22, wherein the chocolate product comprises from about 15% wt. to about 30% wt. cocoa liquor.

32. The method product of claim 22, wherein the chocolate product comprises from about 30% wt. to about 40% wt. sugar.

33. The method of claim 22, wherein the chocolate product comprises from about 12% wt. to about 20% wt. whole soybean powder.

34. The method of claim 22, wherein the chocolate product comprises from about 25% wt. to about 35% wt. cocoa butter.

35. The method of claim 22, wherein the chocolate product comprises about 0.03% wt. vanillin.

36. The method of claim 22, wherein the chocolate product comprises from about 0.4% wt. to about 0.5% wt. lecithin.

37. The method of claim 22, wherein the chocolate product comprises: from about 15% wt. to about 30% wt. cocoa liquor; from about 30% wt. to about 40% wt. sugar; from about 12% wt. to about 20% wt. whole soybean powder; from about 25% wt. to about 35% wt. cocoa butter; about 0.03% wt. vanillin; and from about 0.4% wt. to about 0.5% wt. lecithin.

38. The method of claim 22, the processing comprising refining and conching the mixture.

39. The method of claim 38, the processing comprising refining, dry conching and wet conching the mixture.

40. The method of claim 22, the processing comprising pre-refining and refining the mixture; dry conching the mixture; wet conching the mixture by adding to the mixture during the wet conching stage cocoa butter and an emulsifier.

41. The method of claim 40, wherein about 80% of the total cocoa butter in the final chocolate product is included in the mixture prior to pre-refining and the remainder of the total cocoa butter in the final chocolate product is added to the mixture during the wet conching.
